(19) United States
(12) Patent Application Publication
(10) Pub. No.: US 2024/0152907 A1
(43) Pub. Date: May 9, 2024

(54) SYSTEMS AND METHODS FOR GENERATING AND TRANSMITTING DIGITAL PROOFS OF OWNERSHIP FOR PURCHASED PRODUCTS

(71) Applicant: Solydaria, Inc., Brooklyn, NY (US)

(72) Inventor: Andrew Yakovlev, Brooklyn, NY (US)

(21) Appl. No.: 18/351,973

(22) Filed: Jul. 13, 2023

Related U.S. Application Data
(63) Continuation of application No. 17/699,916, filed on Mar. 21, 2022, now abandoned.
(60) Provisional application No. 63/163,870, filed on Mar. 20, 2021.
(60) Provisional application No. 63/242,089, filed on Sep. 9, 2021.
(60) Provisional application No. 63/242,086, filed on Sep. 9, 2021.

(51) Int. Cl. G06Q 20/36; G06F 21/31; G06Q 20/08; G06Q 20/40; H04L 9/08

(52) U.S. Cl. CPC G06Q 20/3672; G06F 21/313; G06Q 20/085; G06Q 20/3674; G06Q 20/3678; G06Q 20/4015; H04L 9/0819; G06Q 2220/12; H04L 9/50

(57) ABSTRACT

Novel techniques for generating and ascertaining proof of ownership of physical goods employing blockchain-based methodologies. Upon purchase of a physical good, data relevant to that purchase including identification of the purchaser are employed to mint an NFT purchase token that is appended on a block chain and placed within the customer wallet to represent a unique certificate of ownership for the purchased physical good. Transaction fees associated with the process, creation of an electronic wallet, generation of tokens that include sub-tokens for maintaining chain of title information for the good's entire lifetime, among other things also are discussed.

### REFERENCE TO RELATED APPLICATION

This application is a continuation of U.S. application Ser. No. 17/699,916, filed Mar. 21, 2022, which claims priority under 35 U.S.C. 119(e) to U.S. Provisional Patent Application No. 63/163,870, filed Mar. 20, 2021, U.S. Provisional Patent Application No. 63/242,086, filed Sep. 9, 2021, and U.S. Provisional Patent Application No. 63/242,089, filed Sep. 9, 2021, each of which is incorporated herein by reference in their entirety.

### FIELD OF THE INVENTION

The present invention relates to novel techniques for generating, transmitting, and ascertaining proof of ownership of physical (i.e., tangible) goods. More particularly, the invention relates to a blockchain-based process for storing and manipulating physical goods product purchase information on a blockchain network.

### BACKGROUND OF THE INVENTION

Currently, consumers ascertain and confirm that they have purchased, repurchased and/or own products in multiple, often complex, ways. This, in turn, creates issues and inefficiencies that have been generally accepted within most industries. In a world where data is quickly becoming one of the most valuable goods, this status quo is increasingly an issue and a constraint on progress and the economic growth of our society.

The bulk of solutions related to digitally representing a good and certifying custody focus on the “up-stream” and fall into the realm of logistics and authenticity. These solutions are task specific, connected to things like inventory management, sales tracking or shipping and distribution. Furthermore, each solution, and each business, end up owning their own data and siloing it. This prevents, in totality, a macro analysis of economic activity, and severely impedes micro or granular research of consumption and other trends. Middlemen, like credit card companies, end up benefiting from aggregating transactions, but even their understanding is piecemeal.

What this ultimately leads to is incomplete knowledge, an inability to precisely ascertain, on a societal basis, what and how much is being produced, sold and consumed, as well as wasted.

### OBJECTS AND SUMMARY OF THE INVENTION

As will be appreciated from the description to follow, the present invention puts the consumer at the center of the proof of purchase and ownership issue. The invention addresses the long-felt need for simplifying and ensuring ownership certification. The invention provides a secure and suitable replacement for: (a) currently employed emails, text messages or other communications that confirm a purchase; and (b) paper receipts. In these currently used approaches, the data is not secure and prone to easy modification (by the purchaser and/or third parties). Moreover, the data is stored in company databases, each with their own set of potential problems, and often is dependent on unreliable communications (e.g., mail-in forms) and prone to error due to a string of other issues.

By utilizing a unique digital token, the systems and methods of the present invention can be imbued with product, purchase, and even promotional information, which may be securely and reliably transferred from one owner to another person or entity or, if desired, co-owned. In accordance with the present invention, this functionality may be extended “up-stream,” that is, to retailers, wholesalers, distributors, importers, manufacturers, and other entities within the supply chain. The present invention further may be extended “down-stream,” such as to resellers and companies that refurbish or upgrade products.

In accordance with the present invention, participants in the custodial chain can “write” their own specific data to the token and encrypt it in a way so that they “own” the permission to access it, even after they no longer are an owner.

Further, the present invention obviates the need for participants (at each level of the custodial chain, including the “upstream” and “downstream” support chain) to individually store data in their own databases. The present invention instead beneficially sets forth an efficient, secure, and decentralized technique for storing immutable records for purchased goods.

The present invention enables for a standardized protocol for documenting the journey of goods, starting from production, and continuing to distribution and sale, and further continuing to resale through whatever means or process. This includes sale of goods sold from the factory floor directly (or indirectly) to consumers, sales from consumer to consumer, sales from second-hand resellers, refurbishers, and other entities, including those that upgrade products or entail replacements.

As will be appreciated, the present invention provides benefits not just to consumers and retailers, but also to marketers, manufacturers, distributors and other entities involved in the sale or marketing of goods. As described, the token of the present invention carries all relevant purchase information and, if employed and adopted, provides the ultimate, secure methodology/technique for ascertaining and guaranteeing authenticity and ownership of goods and products. This, in turn, advantageously enables goods for yet further commercial/financial exploitation, including their leasing, renting, collateralizing, reselling, aggregating and reusing, as appropriate or applicable.

As described herein, the present invention employs a blockchain-based architecture and mechanism for certifying digital proof of ownership of goods. These and other features and benefits of the invention are described herein.

To achieve the foregoing, the following are brief summaries of the inventive systems and processes that electronically create proof of purchase and ownership using non-fungible electronic cryptographic NFT tokens in accordance with the present invention. In accordance with certain embodiments, the inventive system and corresponding process: receive and process metadata comprising purchase information for a good purchased by a customer; receive and process customer information identifying the customer; select and extract relevant data from the metadata and organize the purchase information; authenticate the metadata and verify that the purchase information is genuine; determine whether the metadata or the customer information includes electronic wallet information; create, if electronic wallet information is not included in the metadata or the customer information, a new electronic wallet for the customer; arrange for minting of an NFT purchase token that represents a unique certificate of ownership for the purchased good; arrange for the minted NFT purchase token to be appended on a blockchain; assign the minted NFT purchase token to the electronic wallet of the customer; and generate a transaction fee for the minting and verification processing, and associate the generated transaction fee with the transaction.

As one aspect of the present invention, a product entry is created that includes a minting fee for minting the NFT purchase token that represents the unique certificate of ownership for the purchased good. The created product entry that includes the minting fee then enables for the minting fee to be paid by the customer who purchased the good.

As a feature of this aspect, the minting fee is updated prior to product purchase, or prior to when the metadata that includes purchase information is assessed.

As another feature, the minting fee is updated from information provided by a minting processor that carries out or causes to be carried out the minting of the NFT purchase token that represents the unique certificate of ownership for the purchased good.

As another aspect of the present invention, the metadata contains a unique identifier adapted to be used to obtain an electronic wallet address in an ID token smart contract.

As a specific feature of this aspect, the unique identifier is a telephone number of the customer.

As another feature, the system/method arranges for the transmission of an SMS code to the telephone number of the customer in the metadata in order to perform verification of the identity of the customer.

As a further aspect of the invention, the system/method arranges for a transmission of an email to the email address contained within the metadata or within the customer information that requests a unique identifier of the customer.

As yet another aspect of the invention, a private key is generated in order to create an identification NFT token and then the created NFT token is assigned using at least a portion of the generated private key.

As yet a further aspect of the invention, the minted NFT purchase token comprises multiple sub-tokens, and each of the sub-tokens includes data about a respectively different entity in the chain of ownership of the purchased good.

As a feature of this aspect, the sub-tokens include confidential data accessible only to the respective entity to which the sub-token pertains.

As an additional aspect of the invention, the metadata that includes the purchase information for the good is generated when the good is purchased by the customer at a location (e.g., a retail store) that represents the point of purchase location.

As a feature of this aspect, data representing the identity of the customer is received when the customer is at the point of purchase location (e.g., during the purchase transaction, or immediately before or after).

The above summaries are representative of the invention, but multiple additional embodiments, aspects and features of the invention, as well as objects and advantages of the invention, are further described in the detailed discussion below.

### BRIEF DESCRIPTION OF THE DRAWINGS

The following detailed description, given by way of example and not intended to limit the present invention solely thereto, will best be appreciated in conjunction with the accompanying drawings, wherein like reference numerals denote like elements and parts, in which:

FIG. 1 is a schematic diagram used for depicting the general processes of certain embodiments of the present invention;

FIG. 2 schematically shows the general architecture of certain embodiments of the present invention;

FIG. 3 is a flow diagram that shows the process flow of certain embodiments of the present invention;

FIG. 4 schematically illustrates the structure and organization of the identity NFT smart contract ID token of the present invention;

FIG. 5 schematically illustrates the structure and organization of an exemplary proof of purchase and ownership token in accordance with certain embodiments of the present invention;

FIGS. 6A-B schematically illustrate nested NFT or the “Token of Tokens” structure and organization of the present invention;

FIG. 7A schematically illustrates a process flow diagram for an eCommerce purchase of the present invention;

FIG. 7B schematically illustrates a process flow diagram for an in-store with cashier point of purchase process of the present invention;

FIG. 7C schematically illustrates a process flow diagram for an in-store cashier-less point of purchase process of the present invention;

FIG. 8 is a schematic illustration of different applications and different entities that may own or possess a product from manufacture to post-sale in accordance with certain embodiments of the present invention.

### DETAILED DESCRIPTION OF THE PRESENT INVENTION

Before setting forth a detailed description of the invention, it is to be understood that the terminology used herein is provided for the purpose of describing various embodiments of the invention and is not intended to represent limitations of the invention unless otherwise expressly stated.

As used herein, the term “and/or” includes any and all combinations of one or more of the associated listed items. The singular forms “a,” “an,” and “the” are intended to include the plural forms as well as the singular forms, unless the context clearly indicates otherwise. The terms “comprises” and/or “comprising” in this specification specify the presence of stated features, steps, operations, elements, and/or components, but do not preclude the presence or addition of one or more other features, steps, operations, elements, components, and/or groups thereof.

The terms “good”, “goods”, “product”, “products”, “item” or “items” (that are made, purchased or sold), as referenced in this specification, refer to goods or services, in singular or plural, unless otherwise expressly specified.

Discussions pertaining to a computer, server, processor, electronic device, computing device, and the like shall include a combination of multiple devices. Language relating to a computer, computing device, electronic device, and the like includes any suitable combination of computing devices, including servers, systems, databases, controllers, engines, interfaces, or other types of devices generally recognized to be used within or associated with computing devices.

Computer, computing devices and electronic devices employ one or more processors configured to execute software instructions that is/are stored on a tangible, non-transitory computer readable storage medium. Computers, computing devices and electronic devices, along with their associated processors and the tangible, non-transitory computer readable storage mediums are well known in the art.

The present invention also has been described as carrying out certain processes or steps. Such processes or steps are carried out by appropriate computers, computing devices, electronic devices, processors or other known components capable of carrying out those processes or steps. Hence, even if structural devices are not always mentioned within each of the various embodiments presented herein, the foregoing mentioned structural devices, such as a processor, computer, computing system, electronic device, etc., represent the structures that may be used in the present invention.

Moreover, the present invention has described a multitude of processes in terms of functions, steps, objectives, and other things, and given the discussion herein, and in light of the discussion herein, a person of ordinary skill in the art to which the present invention applies is able to generate the corresponding code, software applications and “apps.”

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

Novel ownership certification systems and methodologies, among other things, are discussed herein. In the description herein, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description herein.

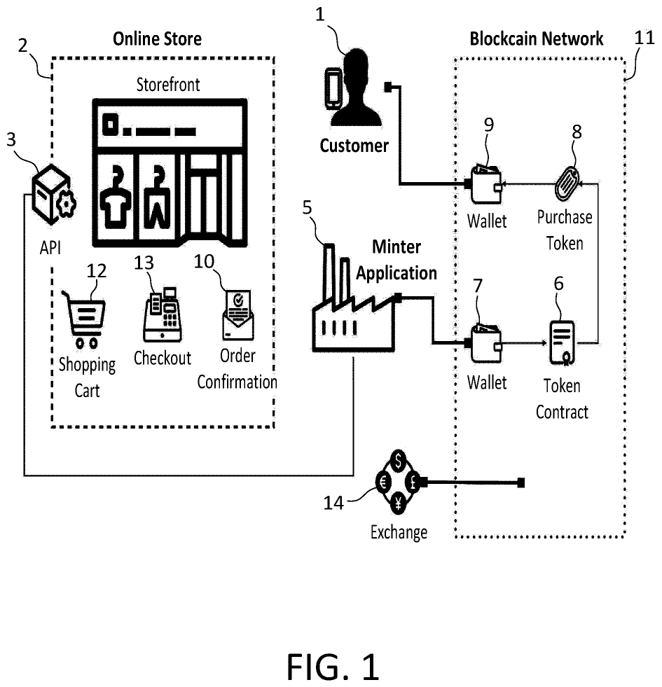

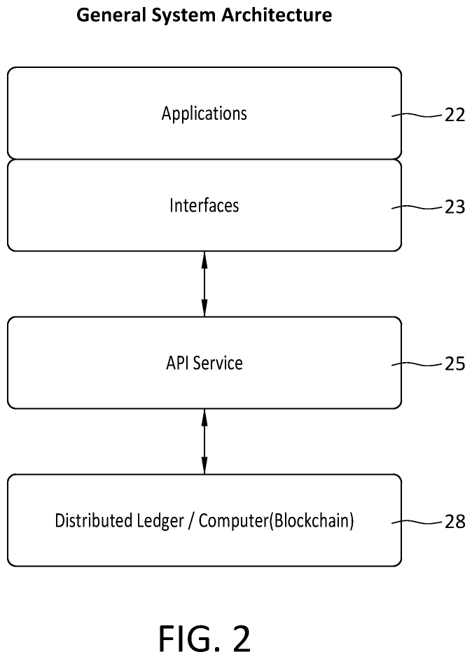

The present invention will now be described with reference to the various figures that illustrate representative embodiments. The general operation and organization of the system and method in accordance with at least one embodiment are described with reference to FIGS. 1 and 2.

General Operation and Layout

Referring to FIG. 1, an online store 2 generates a blockchain purchase token 8 that represents a unique certificate of ownership for an item or good purchased by a customer 1. Generally, the event of purchasing a good occurs at or immediately after payment by the customer to the online store of an agreed-upon price. In some instances, the purchase event occurs at a later time, such as when the good becomes available to the store or at another point in time and then subsequently its ownership is transferred to the customer. Accordingly, the certificate of ownership is created at points in time that may differ from merchant to merchant and depending on the circumstances of the purchase event.

Generation of blockchain purchase token 8 is facilitated by a token minter application 5 that is connected to the store 2 through an application programming interface (API) 3. The API may be executing a computer program by a computer processor, CPU, MPU or multiple processors that execute specific computer code that may be stored in computer memory, such as, for example, Random Access Memory (RAM), Read Only Memory (ROM) or any internal or external memory storing device. The application receives an automatic notification of the completed order via the API 3. Then, the system initiates the electronic token minting or, alternatively, the customer can self-select to initiate the minting process by manually providing the address of their blockchain wallet 9 on the order confirmation page 10. In the latter case, the minter application 5 has additional access, via the API 3, to the store's order history and can verify the customer request as genuine by authenticating metadata, such as, for example, an order number and/or an order timestamp, or other identifier.

The completed order notification and/or confirmation requested by the minter application 5 contains a data object that carries metadata related to the order and the purchased good. In at least one embodiment, the metadata includes identifying information such as store name, item brand, purchase price, time and date, product SKU, variant ID, image, web links, physical properties, serial number (or other authenticating signature that can be physically stored in or within an item), referral codes, and/or other properties and information, or a combination of these items.

Token contract 6 is an autonomous application hosted on the blockchain network 11. Within it are functions and routines related to the generation or minting of purchase tokens, their ownership transfer, as well as functions for writing and reading the metadata stored on the tokens. The contract 6 also maintains a ledger of tokens generated and transferred. Only transactions such as minting or transfer can be added to the ledger, and it cannot be modified or redacted in any other way. The same goes for the contract; it cannot be deleted or modified in any other way, the exception being the additive functionality of the ledger.

An illustrative scenario of the invention's function is as follows. A customer enters a store 2 and selects a product to buy by placing it in the store's shopping cart 12. The customer proceeds to checkout 13, where they enter personally identifying information such as email or username along with shipping and payment information (or logs into one's account in manners well known). Then, upon confirmation and successful order placement, they are directed to an order confirmation page 10. At this time, the store's API sends the completed order notification outlined above, including customer identifying information, to the minter application 5.

The minter application 5 proceeds to assemble a transaction to be sent to the blockchain network 11. The transaction is essentially a call to the mint function encoded on the token contract 6 and contains all the information necessary for the blockchain network 11 to process. The minter application itself can store data linking the customer's identifying information to their wallet's address, or it can call another application to ascertain the address. The transaction, once assembled, contains the customer's wallet address, the metadata received from the store, the contract code, network processing fee payment information, and the minter application's wallet's signature which contains the wallet's address and a private key. Once the transaction calling the minting function on the contract is sent to the blockchain network 11 and the fees associated with it are paid from the minter application's wallet, the contract is run and generates a new purchase token 8 that is assigned to the customer's wallet.

In the embodiments discussed above, the minter application pays the transaction fee. In accordance with another embodiment of the invention, the customer pays the transaction fee. The minter application 5, via the API 3, creates and maintains a product entry in the store's product database. This product is the minting fee. Upon adding a product eligible to have a digital twin, the purchase token 8, either automatically or through an opt in, to the shopping cart 12, the minting fee product item is added. Thus, the purchaser/customer becomes responsible for the payment of the minting fee. Similarly, in another embodiment, the minting fee may constitute or include an additional cost of verification of the purchase or transfer documentation. This could be the cost of Proof-of-Stake confirmation by an authentication mining app on a blockchain and/or the reword to the authentication mining app for confirming and authenticating the payment (by solving a cryptographic problem or performing some other specified process as part of the confirmation and authentication of the proof of purchase documentation/receipts).

The price/cost of the minting fee product can be updated periodically or just prior to being added to the shopping cart by the minter application 5. The cost may be ascertained using any known technique or methodology including accessing current applicable exchange rates (exchange 14), minting rates, etc., or may be set to reflect a percentage of the cost of the good, or other manner.

Upon completing the order, an order notification is sent to the minter application, which proceeds to verify that the order also contains the minting fee product item before initiating the minting process discussed above.

Once the purchase token is linked to the customer's wallet, the customer is entitled to a variety of benefits based on this certificate of ownership. Benefits may include purchase rebates, other marketing rewards, warranties, ability to resell or return the good, the ability to lease/rent the good, granting access to third parties to the information on the token, and other benefits that are known to be available to owners.

To return a physical good, the owner initiates the return in accordance with the invention by returning both the physical good and sending back the token to the minter application's wallet before it is burned or stored away. To grant access to third parties, a key token is generated that allows the decryption of the data stored on the purchase token which will be encrypted in whole or partially at the time of minting.

In further embodiments of the invention, the inventive process is extended “up-stream.” In such embodiments, the token is minted upon production of the product, and then transferred to parties as custody of the good changes. The minter application and smart contract code can be modified holders of tokens, or users with certain roles, to write and append additional metadata to the token, by ascertaining their ownership of the token and role to the minter application. This metadata may be encrypted so that only certain roles, or certain entities in the full life cycle of the good, can have access to such data. In the event of authentication, this permanent chain of custody, even if encrypted, could serve as a powerful proof of the good's authenticity.

Additionally, all the data stored on the token regarding its physical twin's journey from the factory floor to the hands of the consumer will be valuable to parties doing any manner of research or analysis regarding societies' production, distribution, marketing and consumption of goods.

The general system and architecture of a system and software in accordance with certain embodiments is described with reference to FIG. 2. The present invention utilizes a blockchain, which is a distributed ledger, operating on a distributed computerized network, storing the ledger information as linked nodes on a blockchain. The present invention may operate on a blockchain 28 that supports smart contracts executable logic as part of the information and as executable instructions that are executed by the processors on the blockchain and/or the miners in order to determine whether to generate and then generate a new entry on a blockchain, and also to determine the validity of the new entry on the ledger, which can represent a transaction involving a particular good.

The blockchain architecture works as an alternative to a centralized database architecture that is commonly used for storing information about goods. One of several benefits of utilizing a distributed ledger and a blockchain architecture for storing product-related information on a blockchain is that it removes the need for “middleware.” The smart contract architecture of a blockchain, like Ethereum 2.0 or another blockchain that allows smart contract processing, provides an ability to store product data and execute business logic that may be associated with the transaction. Moreover, the blockchain allows both to be done immutably and provides for security encryption to safeguard the ownership data, as well as some product-related and transaction-related information.

API Service 25 is a modular software component that is executed by one or more processors, which implement(s) the method, steps and operation of the present invention in accordance with certain embodiments described herein. API Service 25 may be implemented to communicate with the blockchain 28 layer via a REST API or RESTful, which allows developers of blockchain applications to send, store, read/write, encrypt/decrypt and operate data on the blockchain. The access may be granted via API tokens.

Application(s) 22 is a software component that operates the entity-specific, product-specific, platform-specific or user-specific operations, such as, for example, the data collection forms and screens about the product, transaction entry processing, user-specific security settings and administration, wallet-operating software components, wireless transactions and NFT processing for particular hardware devices, etc. Application 22 layer may be connected to the API service 25 through an Interface 23 layer that may be fully or partially initialized and organized for each application 22 that is organized by a merchant, seller, manufacturer, buyer or any other entity “up” or “down” the manufacturing and sales chain, or product life.

Interface 23 represents software, executable code, organizational components and data components that may reside in any Mobile/WebApp and facilitate communication with the API services 25 layer. For example, application 22 may be the personal data and space for a user of a Shopify platform, which enables the purchase of various goods and services along with payment processing. Interface 23 may be, for example, the Shopify plug-in software components that integrate the Shopify platform with API services 25 that execute and implement the processing in accordance with the present invention.

Illustrative Process Flow

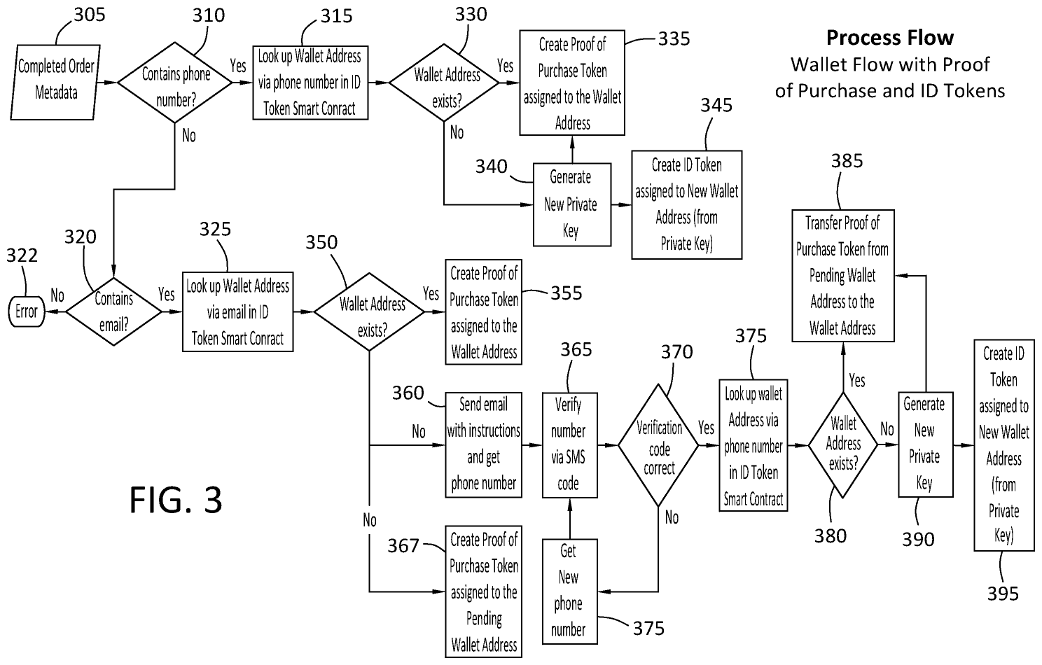

FIG. 3 is an illustrative schematic flow diagram of the process flow of the proof of purchase system and method in accordance with certain embodiments of the present invention.

A completed purchase order and/or metadata about a completed purchase order is processed by a computer processor at step 305. At step 310, it is determined whether the metadata contains a phone number of the purchaser or user. In at least one embodiment, the phone number may be used as a key identifier. In other embodiments, any other number or id that is assigned to or is commonly used may be used as a key identifier. Alternatively, a random number generator may generate and assign a unique number for each purchase of an item, transaction or the user, and then the generated unique key is utilized for wallet and NFT operations. In another embodiment, biometric information, such as a digital fingerprint, eye retina scan or some other unique identification mechanism can be utilized to correctly confirm user identity.

At step 315, the system uses the phone number (or other unique identifier) to look up the wallet address in the ID token smart contract. If the wallet address exists (step 330), then the system creates a Proof of Purchase Token (step 335), which is assigned to the wallet address. On the other hand, if step 330 ascertains that a wallet address does not exist, then the processor (in step 340) executes suitable code to generate (or otherwise obtain) a new private key. In an alternative embodiment, the generation of a private key may involve generation of a public and private key pair. The generated private key is used in step 345 to create an ID token that is then assigned to a new wallet address (from the private key).

In at least one embodiment, the wallet is a randomly generated string, that is, the private key. A public key may be generated from the private key and works as the wallet address. The private key may be used to authenticate instructions sent to smart contracts. If an embodiment utilizes SMS authentication for verification of the user's identity, the phone number is used as a key identifier in one embodiment. In other embodiments/versions, the wallet and identification may be tied to something else, such as an email address or a passcode.

Since most people have a cell phone, the cell phone number is tied, in a sense, to the identity of the person. Hence, cell phone numbers represent an efficient way to manage user authentication without further need for identifiers (in one embodiment). In the illustrative flow chart shown in FIG. 3, the phone number is the key identifier and the email address is utilized to obtain the phone number that is then associated and assigned to the wallet that holds the NFT for the purchased or transferred good.

Referring again to step 310 in FIG. 3, if the inventive system/process determines that the completed purchase order (or purchase order metadata) does not contain a phone number (or other unique identifier in other embodiments), the system/process ascertains in step 320 whether it contains an email address. If not, an error issues (step 322). If so, the email address is utilized to look up the wallet address in the ID token smart contract (step 325).

Thereafter, the system/process ascertains in step 350 whether or not the wallet address exists for the completed purchase order. If so, the system/process creates in step 355 a proof of purchase token and assigns it to the wallet address that is associated with the completed purchase order. That is, upon purchase of a good by a consumer, the proof of purchase token is associated with and assigned to that purchaser's wallet address.

If, however, there is no wallet address (step 350), the system/process proceeds to automatically generate an email (based on the email address) and sends it with instructions to provide a phone number for the completed purchase order (step 360). Then, the phone number is verified via an SMS code (step 365). Moreover, if the wallet address does not exist (as determined in step 350), the system/process creates a proof of purchase token, which is assigned to a pending wallet address (step 367).

At step 370, the inventive system/process determines if the SMS code is properly verified. If so, the phone number is utilized in step 375 to look up the wallet address. If not, a new phone number is obtained (step 375) and the verification via an SMS code is repeated in step 365.

Thereafter, if it is determined that the wallet address exists (at step 380), the system/process transfers in step 385 the proof of purchase token from the pending wallet address to the looked-up wallet address. For instance, a transfer from the seller's wallet to the purchaser's wallet is carried out.

If, however, there is no wallet address (as determined in step 380), the system/process generates a new private key in step 390 and then creates in step 395 an ID token that is assigned to a new wallet address (from the generated private key).

ID Management—ID Token Structure and Organization

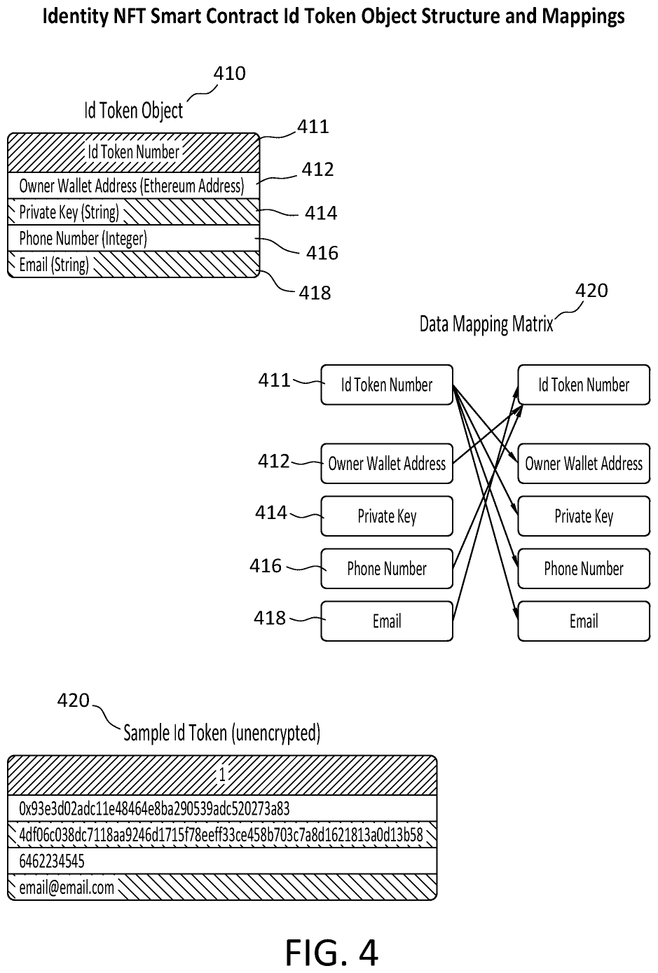

The identity NFT smart contract ID token, and its object structure, interrelation and mapping of different fields are discussed with reference to FIG. 4. The ID Token Object 410 includes an ID token number 411, which is a unique identification number for each NFT token. It may also include the owner wallet address 412, which in at least one embodiment can be Ethereum blockchain address. It may also include a private key 414, which could be an encrypted string, a phone number 416 or other unique identifier and/or the email address 418 of the owner, user, or other entity.

As shown in FIG. 4, the fields of the ID token object may be organized as a data mapping matrix 420. In this mapping, the ID token number 411 is mapped to all other fields 412, 414, 416, 418, and there may be a back link or map for each of those fields to the ID token number.

In at least one embodiment, the system may use another NFT as an Id token. It is based on the ERC-721 NFT standard, with some mapping modifications to make look-up easier, as well as to make the storage of data on the chain simpler. Every token has a numeric integer (e.g., Unit 256) identifier to which data is mapped (as shown in FIG. 4). In at least one embodiment, the data is organized to map the phone number, email, and private key to each token number. Thus, the software that utilizes this architecture and mapping technique can search for the token number by phone or email through a smart contract function. Or, if it looks up a token number using the smart contract function, it can get all those data values.

Private Key Management—Split Key Cryptography

The Ethereum private key is 32 random bytes. Instead of storing the entire 64-character string in the Id token object, the present invention, in at least one embodiment, splits it in half, leaving the first 16 bytes in the Id token object, and storing the other half in a different vaulted smart contract specifically dedicated to mapping the 16 bytes to an Id token number. The vaulted smart contract has, in certain embodiments, a stricter permissioned access logic where the second half of the key is “checked out” or is provided as a temporary access code.

In at least one embodiment, the system uses the private key as follows. While it is not required for minting an NFT token into the owner wallet, or transferring other token (ERC-20) to the wallet (e.g., from the merchant to the purchaser), the private key is needed and is used to transfer NFT Tokens out of the wallet (in accordance with at least one embodiment).

In at least one embodiment, by utilizing split key cryptography, the system optionally encrypts all the data in the Id token object below the owner's wallet address.

The organization and structure of the stored metadata object that is stored on the proof of purchase NFT is provided below in Table 1 below:

```
TABLE 1
“Metadata”: {
  “name”: “Bandana - Black”, “vendor”: “Solydaria”, “price”: 15,
  “product_id”: 7178268737689,
  “variant_id”: 41449514270873,
  “url”: “https://solydaria.myshopify.com/products/bandana---black”, “quantity”: 1,
  “orderNumber”: 1088,
  “processed_at”: “2021-11-01T22:43:32-04:00”
```

The “Metadata” NFT object stores the following information about the proof of purchase of a product: name, vendor, price, product id, variant id, url, quantity, order number and processed at information (i.e., a timestamp). These informational data items are selected as the most relevant to the proof of purchase NFT and product information in accordance with at least one embodiment. However, they may be organized in any order and additional product information fields may be added to these specific product and purchase data items.

The Proof of Purchase and Ownership Token (NFT)—Object Structure and Mapping

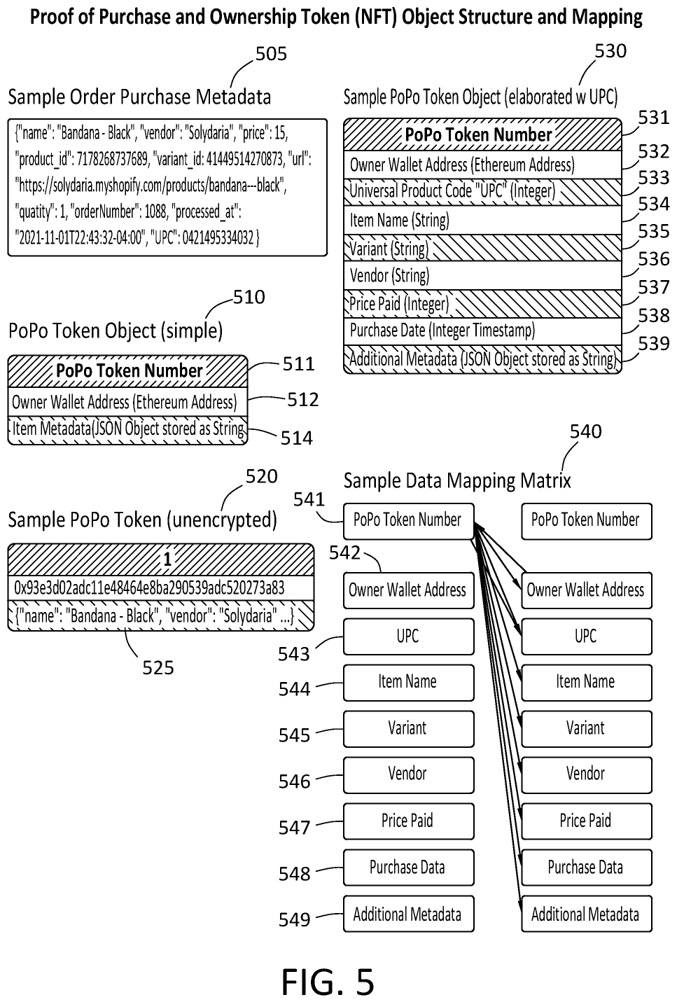

The organization and structure of a proof of purchase and ownership token (NFT) in accordance with the present invention are described with reference to FIG. 5. The Sample Order Purchase Metadata 505 includes information about: product name/color, vendor, price, product id, variant id, url, quantity, order number, and processed at (timestamp). This metadata includes the key information that is selected about the item that is manufactured, distributed, sold and/or resold.

The proof of purchase token object 510 in accordance with at least one embodiment includes a token number 511, owner wallet address 512 and item metadata 514. The sample purchase metadata 505 is an example of the item metadata.

An exemplary proof of purchase token (unencrypted) 520 also is shown in FIG. 5. The item information that is stored in the token object with elaborated UPC 530 includes: (1) unique token number 531; (2) owner wallet address (e.g., an Ethereum address) 532; (3) the universal product code (UPC) 533; (4) item name 534; (5) variant 535; (6) vendor 536; (7) price paid 537; (8) purchase data 538; and (9) additional metadata (a JSON Object that may be stored as a string). These informational data items are selected as the most relevant to the proof of purchase NFT and product information in accordance with at least one embodiment. However, they may be organized in any order and additional product information fields may be added as the additional metadata 539. In certain embodiments, few data items are included in the object.

The fields of the token number of the proof of purchase token are organized into a sample data mapping matrix 540, where the proof of purchase token number 541 is linked or mapped to all other fields 542-549 of the token, and each of those fields may have a back link or mapping to the ID token number. 541.

The proof of purchase NFT token architecture, in accordance with certain embodiments, is an alternative to any type of centralized database (e.g., relational, hierarchical, graph, files, etc.). The purchase data is stored as discrete objects (NFT tokens) by assigning the tokens to the owner wallet. In at least one embodiment, the full purchase metadata is processed. The purchase metadata that is generated at the time of sale, which combines a significant amount of information, includes item information (e.g., UPC), purchase information (e.g., purchase price, purchase location), and buyer information (e.g., email address, shipping address, payment method, etc.). In further embodiments, the purchase metadata include additional data items that are not necessarily critical for the purpose of keeping the proof of purchase data up or down stream from the manufacturer to consumer and other entities.

For example, a full purchase order metadata (JSON) may have a lot of different and often unnecessary information, as illustrated in Table 2 below. From this extensive collection of data items, the specific information is automatically extracted and utilized as part of the proof of purchase NFT token architecture in accordance with at least one embodiment.

```
TABLE 2
  PurchaseOject: {
      id: 4172163154073,
      admin_graphql_api_id: ‘gid://shopify/Order/4172163154073’,
      app_id: 580111,
      browser_ip: ‘24.191.54.92’,
      buyer_accepts_marketing: false,
      cancel_reason: null,
      cancelled_at: null,
      cart_token: ‘c49ed37ad437235845b78b3bb72deaac’,
      checkout_id: 22672813097113,
      checkout_token: ‘0efaa581696f42a0cf9a91df952be5e8’,
      client_details: {
        accept_language: ‘en-us',
        browser_height: 798,
        browser_ip: ‘24.191.54.92’,
        browser_width: 1224,
        session_hash: null,
        user_agent: ‘Mozilla/5.0 (Macintosh; Intel Mac OS X 10_15_7)
AppleWeb Kit/605.1.15 (KHTML, like Gecko) Version/15.0 Safari/605.1.15’
      },
      closed_at: null,
      confirmed: true,
      contact_email: ‘andrew@test.com’.
      created_at: ‘2021-10-22T20:25:40-04:00’,
      currency: ‘USD’,
      current_subtotal_price: ‘52.00’,
      current_subtotal_price_set: {
        shop_money: { amount: ‘52.00’,
        currency_code: ‘USD’ },
        presentment_money: { amount: ‘52.00’,
        currency_code: ‘USD’ }
      },
      current_total_discounts: ‘0.00’,
      current_total_discounts_set: {
        shop_money: { amount: ‘0.00’,
        currency_code: ‘USD’ },
        presentment_money: { amount: ‘0.00’,
        currency_code: ‘USD’ }
      },
      current_total_duties_set: null,
      current_total_price: ‘53.96’,
      current_total_price_set: {
        shop_money: { amount: ‘53.96’,
        currency_code: ‘USD’ },
        presentment_money: { amount: ‘53.96’,
        currency_code: ‘USD’ }
      },
      current_total_tax: ‘1.96’,
      current_total_tax_set: {
        shop_money: { amount: ‘1.96’,
        currency_code: ‘USD’ },
        presentment_money: { amount: ‘1.96’,
        currency_code: ‘USD’ }
      },
      customer_locale: ‘en’, device_id:
      null,
      discount_codes: [ ],
      //email: ‘andrew5@test.com’,
      email: null,
      estimated_taxes: false,
      financial_status: ‘paid’,
      fulfillment_status: null,
      gateway: ‘bogus',
      landing_site: ‘/password’,
      landing_site_ref: null,
      location_id: null,
      name: ‘#1077’,
      note: ‘’,
      note_attributes: [ ],
      number: 77,
      order_number: 1086,
      order_status_url:
‘https://solydaria.myshopify.com/58641744025/orders/7
9a6f677464f7d44ec4a276126c94d72/authenticate?key=a709a69c5fa9535cf5fb824ed
745 7fb3’,
      original_total_duties_set: null,
      payment_gateway_names: [ ‘bogus' ],
      phone: ‘+16464151119’,
      phone: null,
      presentment_currency: ‘USD’,
      processed_at: ‘2021-10-22T20:25:39-04:00’,
      processing_method: ‘direct’,
      reference: null,
      referring_site: ‘’,
      source_identifier: null,
      source_name: ‘web’, source_url:
      null,
      subtotal_price: ‘10.00’,
      subtotal_price_set: {
        shop_money: { amount: ‘52.00’,
        currency_code: ‘USD’ },
        presentment_money: { amount: ‘52.00’,
        currency_code: ‘USD’ }
      },
      tags: ‘ ’, tax_lines: [
        {
          price: ‘0.09’,
          rate: 0.00375,
          title: ‘Kings County Tax’,
          price_set: [Object],
          channel_liable: false
        },
        {
          price: ‘0.88’,
          rate: 0.04,
          title: ‘New York State Tax’,
          price_set: [Object],
          channel_liable: false
        },
        {
          price: ‘0.99’,
          rate: 0.045,
          title: ‘Brooklyn City Tax’,
          price_set: [Object],
          channel_liable: false
              }
            ],
      taxes_included: false,
      test: true.
      token: ‘79a6f677464f7d44ec4a276126c94d72’,
      total_discounts: ‘0.00’,
      total_discounts_set: {
        shop_money: { amount: ‘0.00’,
        currency_code: ‘USD’ },
        presentment_money: { amount: ‘0.00’,
        currency_code: ‘USD’ }
      },
      total_line_items_price: ‘52.00’,
      total_line_items_price set: {
        shop_money: { amount: ‘52.00’,
        currency_code: ‘USD’ },
        presentment_money: { amount: ‘52.00’,
        currency_code: ‘USD’ }
      },
      total_outstanding: ‘0.00’,
      total_price: ‘53.96’,
      total_price_set: {
        shop_money: { amount: ‘53.96’,
        currency_code: ‘USD’ },
        presentment_money: { amount: ‘53.96’,
        currency_code: ‘USD’ }
      },
      total_price_usd: ‘53.96’,
      total_shipping_price_set: {
        shop_money: { amount: ‘0.00’,
        currency_code: ‘USD’ },
        presentment_money: { amount: ‘0.00’,
        currency_code: ‘USD’ }
      },
      total_tax: ‘1.96’,
      total_tax_set: {
        shop_money: { amount: ‘1.96’,
        currency_code: ‘USD’ },
        presentment_money: { amount: ‘1.96’,
        currency_code: ‘USD’ }
      },
      total_tip_received: ‘0.00’,
      total_weight: 0,
      updated_at: ‘2021-10-22T20:25:41-04:00’,
      user_id: null,
      billing_address: {
        first_name: ‘’,
        address1: ‘11 Hoyt Street’,
        phone: null,
        city: ‘Brooklyn’,
        zip: ‘11201’,
        province: ‘New York’,
        country: ‘United States',
        last_name: ‘g’, address2: ‘’,
        company: null, latitude:
        40.6899456,
        longitude: −73.98504659999999,
        name: ‘g’,
        country_code: ‘US’,
        province_code: ‘NY’
      },
      customer: {
        id: 5754081443993,
        email: ‘andrew@test.com’,
        accepts_marketing: false,
        created_at: ‘2021-10-22T20:09:28-04:00’,
        updated_at: ‘2021-10-22T20:25:41-04:00’,
        first_name: ‘’,
        last_name: ‘g’,
        orders_count: 0,
        state: ‘disabled’,
        total_spent: ‘0.00’,
        last_order_id: null,
        note: null,
        verified_email: true,
        multipass_identifier: null,
        tax_exempt: false,
        phone: null,
        tags: ‘’,
        last_order_name: null,
        currency: ‘USD’,
        accepts_marketing_updated_at: ‘2021-10-22T20:09:28-04:00’,
        marketing_opt_in_level: null,
        tax_exemptions: [ ],
        sms_marketing_consent: null,
        admin_graphql_api_id: ‘gid://shopify/Customer/5754081443993’,
        default_address: {
          id: 6943836995737,
          customer_id: 5754081443993,
          first_name: ‘’,
          last_name: ‘g’,
          company: null,
          address1: ‘11 Hoyt Street’,
          address2: ‘’,
          city: ‘Brooklyn’,
          province: ‘New York’,
          country: ‘United States',
          zip: ‘11201’,
          phone: null,
          name: ‘g’,
          province_code: ‘NY’,
          country_code: ‘US’,
          country_name: ‘United States',
          default: true
              }
            },
      discount_applications: [ ],
      fulfillments: [ ], line_items: [
        {
          id: 10705688494233,
          admin_graphql_api_id: ‘gid://shopify/LineItem/10705688494233’ ,
          fulfillable_quantity: 1,
          fulfillment_service: ‘manual’,
          fulfillment_status: null,
          gift_card: false,
          grams: 0,
          name: ‘Blenders Sunglasses',
          origin_location: [Object],
          price: ‘10.00’,
          price_set: [Object],
          product_exists: true,
          product_id: 7119959982233,
          properties: [ ],
          quantity: 1,
          requires_shipping: true,
          sku: ‘’, taxable:
          true,
          title: ‘Blenders Sunglasses',
          total_discount: ‘0.00’,
          total_discount_set: [Object],
          variant_id: 1224717009049,
          variant_inventory_management: null,
          variant_title: ‘’,
          vendor: ‘Solydaria’,
          tax_lines: [Array],
          duties: [ ],
          discount_allocations: [ ]
        },
        {
          id: 10705688527001,
          admin_graphql_api_id: ‘gid://shopify/LineItem/10705688527001’,
          fulfillable_quantity: 1,
          fulfillment_service: ‘manual’,
          fulfillment_status: null,
          gift_card: false,
          grams: 0,
          name: ‘Apotheke Charcoal Candle’,
          origin_location: [Object],
          price: ‘12.00’,
          price_set: [Object],
          product_exists: true,
          product_id: 7123960168601,
          properties: [ ],
          quantity: 1,
          requires_shipping: true,
          sku: ‘’,
          taxable: true,
          title: ‘Apotheke Charcoal Candle’,
          total_discount: ‘0.00’,
          total_discount_set: [Object],
          variant_id: 41241316360345,
          variant_inventory_management: ‘shopify’,
          variant_title: ‘’,
          vendor: ‘Solydaria’,
          tax_lines: [Array],
          duties: [ ],
          discount_allocations: [ ]
        },
        {
          id: 10705688559769,
          admin_graphql_api_id: ‘gid://shopify/LineItem/10705688559769’,
          fulfillable_quantity: 2,
          fulfillment_service: ‘manual’,
          fulfillment_status: null,
          gift_card: false,
          grams: 0,
          name: ‘KAWS Toy’,
          origin_location: [Object],
          price: ‘15.00’,
          price_set: [Object],
          product_exists: true,
          product_id: 7000101159065,
          properties: [ ],
          quantity: 2,
          requires_shipping: false,
          sku: ‘’,
          taxable: false,
          title: ‘KAWS Toy’,
          total_discount: ‘0.00’,
          total_discount_set: [Object],
          variant_id: 40871000768665,
          variant_inventory_management: ‘shopify’,
          variant title: ‘’,
          vendor: ‘Solydaria’,
          tax_lines: [ ],
          duties: [ ],
          discount_allocations: [ ]
              }
            ],
      payment_details: {
        credit_card_bin: ‘1’,
        avs_result_code: null,
        cvv_result_code: null,
        credit_card_number: ‘.... .... .... 1’,
        credit_card_company: ‘Bogus'
      },
      payment_terms: null,
      refunds: [ ],
      shipping_address: {
        first_name: ‘’,
        address1: ‘11 Hoyt Street’,
        phone: null,
        city: ‘Brooklyn’,
        zip: ‘11201’,
        province: ‘New York’,
        country: ‘United States',
        last_name: ‘g’,
        address2: ‘’,
        company: null,
        latitude: 40.6899456,
        longitude: −73.98504659999999,
        name: ‘g’,
        country_code: ‘US’,
        province_code: ‘NY’
      },
      shipping_lines: [
        {
          id: 3516941992089,
          carrier_identifier: null,
          code: ‘Economy’,
          delivery_category: null,
          discounted_price: ‘0.00’,
          discounted_price_set: [Object],
      phone: null,
      price: ‘0.00’,
      price_set: [Object],
      requested_fulfillment_service_id: null,
      source: ‘shopify’,
      title: ‘Economy’,
      tax_lines: [Array],
      discount_allocations: [ ]
      }
      ]
    }
```

This, or similar, metadata is processed on the API services level (see, e.g., FIG. 2) in accordance with at least one embodiment of the present invention. Personal information may be stripped and used only to find or create a new wallet. Then, the item and purchase information is packed into a string written to the NFT at the time of the NFT minting. Additionally, the NFT format can be further enhanced to set up mapping structures that allow for faster data access and information retrieval in accordance with at least one embodiment. Additionally, this data can be encrypted fully or partially.

The system and method of the present invention, in accordance with at least one embodiment, allows for a variety of point of purchase NFT structures, or vintages, all to be stored within the same wallet. As the system evolves or more data needs to be stored as structured fields inside the NFT object (vs just a full JSON object string), there is no need to migrate old NFTs to new formats. All data can be accessed as the NFT smart contract for each vintage also contains instructions that indicate how to access the data and how it is structured and organized.

Master Token Architecture—Nested NFT or “Token of Tokens”

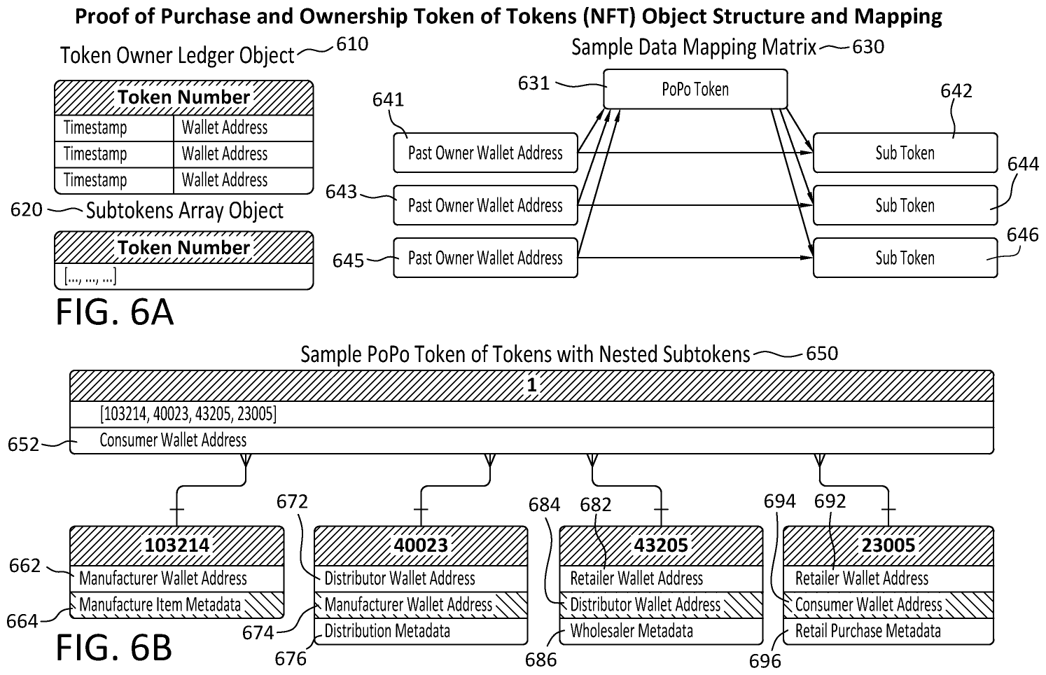

In accordance with certain embodiments of the invention, the NFT structure is organized by nesting other NFTs inside the main item NFTs. This allows for a granular, single item-based record of the entire product journey. Moreover, this structure enables all participants of the journey (and/or different stages of ownership of the good) to maintain access to their own specific data regarding the good in an efficient and decentralized fashion. This architecture/embodiment of the present invention is explained with reference to FIGS. 6A-B.

As will be appreciated, the “Token of Tokens” and the master token architecture of the present invention are analogous to beads on a string. In the analogy, the proof of purchase token is the string, and the beads on that string are the sub-tokens that contain event specific and/or entity specific information. As one example, three sub-tokens respectively contain information about the manufacturer, the distributor, and the retailer of the good. A fourth sub-token contains information about the initial purchaser. The token of tokens is extendable to other participants in the supply chain or the life cycle of a good/token, and may further extend to information about the good's aftermarket life, all the way through disposal, repurposing and/or recycling. As stated above, beyond information about the identity of the various parties involved with the good, other information is included in other embodiments. Such other information includes any data about the good as mentioned herein (e.g., pricing), and/or location(s) of ownership or use, actual purpose or usage of the good (e.g., if repurposed), etc.

In other embodiments, a reward or benefit (or multiple rewards/benefits) is dispensed or otherwise provided to all or select participants in the chain of ownership of the good along the good's entire journey, via each party's respective wallet or via other technique. As one example, a recycler upon evaluation of salvageability of a good can dispense a reward to the consumer and/or the manufacturer (or other entity within the supply, distribution or ownership chain) to encourage each party to optimize product manufacture, product usage, etc. This may be achieved to provide an ultimate benefit to society such as to minimize environmental impact (e.g., to reduce a good's carbon footprint) and/or to provide a benefit to select parties, as appropriate.

Via the Token of Tokens embodiments of the present invention, entities have the ability to provide the above-described reward/benefit to all or select parties within the chain of ownership and the full life cycle of an individual good. In certain embodiments, each entity has access to some or most of the data within the token of tokens for a good, but select information is maintained confidential to each respective entity, even after ownership has changed hands. For example, it may be desirable for an entity (e.g., the manufacturer) to keep warranty information about the good confidential. As another example, a retailer has the ability to keep cost information (or other data) confidential, if desired. Accordingly, in accordance with the invention in these embodiments, each owner has the ability to access all non-protected data within the token of tokens and the ability to identify data to be stored that only it has access.

Referring to FIG. 6A, an exemplary data mapping matrix 630 of the proof of purchase token 631 is illustrated. As shown, the token includes wallet address 641, 643 of prior owners of the good and the wallet address 645 of the current owner, along with their respective sub-tokens 642, 644, 646.

An exemplary token owner ledger object 610 as shown in FIG. 6A includes timestamp and wallet address for each owner. In other versions, other information is included for each owner.

In other embodiments, additional access permissions/logic is included where read access is granted to another select entity in the chain of title or in the life cycle of a good associated with an NFT. The other entity (or entities) can be manually identified upon creation of a sub-token or can be automated. For instance, cost or sale price information can be programmed to be accessible to the prior owner and/or to the subsequent owner, as desired. Accordingly, multiple owners or entities with an interest in a good are given the ability to read the same sub-token.

An exemplary proof of purchase master token 650 is illustrated in FIG. 6B. As shown, several nested sub-tokens are shown, wherein a first sub-token includes the manufacturer wallet address 662 and manufacturer metadata 664. In the exemplary master token, the second sub-token includes the distributor's wallet address 672, the manufacturer's wallet address 674, and the distributor's (or “distribution”) metadata 676. The third sub-token includes the retailer (or wholesaler) wallet address 682, the distributor wallet address 684, and the wholesaler metadata 686. Finally, the fourth sub-token includes the retailer wallet address 692, the consumer wallet address 694, and the retail purchase metadata 696. FIG. 6B is exemplary and other formats, sub-tokens and data (including metadata) may be included within each of the sub-tokens.

As stated above, the token of tokens architecture/embodiments of the present invention beneficially enables entities with the ability to perform various functions not otherwise achievable. In essence, the present invention enables for the creation and safe storage and access by the relevant parties of data relevant to a good, including the entire chain of title, throughout the good's entire life span.

POS Integration

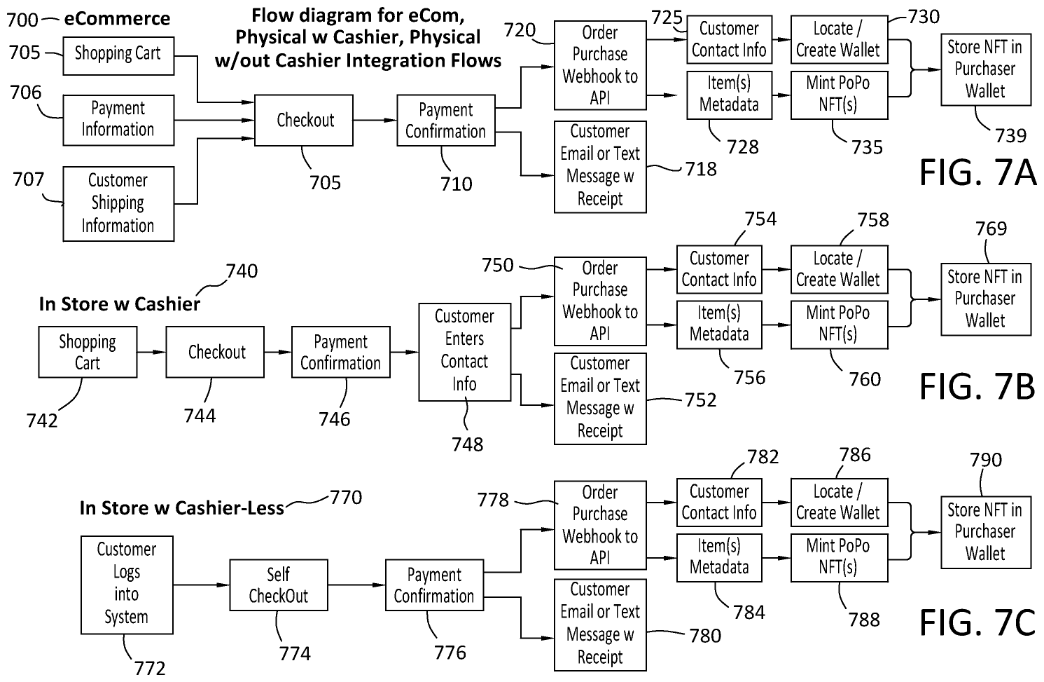

Referring now to FIGS. 7A, 7B and 7C, various flow diagrams are presented that show the flow of the present invention in various embodiments, including during use in e-Commerce, use in-store with a cashier, and use in-store without a cashier.

Referring first to the eCommerce embodiment 700 shown in FIG. 7A, during shopping online, whether via a web browser, an app, or other technique, a customer employs a shopping cart 705 to select goods for purchase, and proceeds in standard ways to purchase the selected goods. Payment information 706 is provided along with customer shipping information 707. Check out 705 and payment confirmation 710 proceed in any manner known in the art.

Thereafter, in accordance with the present invention, data associated with the purchase is routed, via a webhook or other technology, to an API (720) that, in turn, implements the above-discussed processes. For instance, the application plugin instructs the platform to route the order metadata to the API via webhook or other appropriate push technology, wherein the API listens for incoming webhooks from authorized sources and then processes them to thereafter mint a proof of purchase NFT for the customer's wallet. The customer also receives an email, text message or other communication that includes a receipt for the good just purchased (718).

In accordance with the invention, the customer contact info 725 is utilized to locate or otherwise create a wallet for the customer (730). Moreover, metadata of the purchase is extracted and selectively processed (728) and an NFT for the proof of purchase is minted (735). The minted NFT (with the proof of purchase information) and in various embodiments, the chain of ownership and other information, is stored into the purchaser's wallet (739). Additional variations and other features are as discussed herein.

FIG. 7B illustrates application 740 of the present invention within a retail store wherein a cashier assists in carrying over the purchase of one or more goods. Similar to the eCommerce embodiments, the customer places one or more goods in a real shopping cart (742) and then proceeds to check out (744), at which points the purchase transaction is conducted. Upon payment, payment confirmation (746) is made in any known manner.

Either before, during or after payment (or payment confirmation), the customer provides his/her contact information (748). This may occur automatically or manually. In cases where the customer provides a credit card (or debit card) for payment, customer identification information may be automatically extracted in known ways. The customer may provide a loyalty program card or other indicator during the transaction that enables the system to identify the customer. Other automated manners of identification can be employed, such as via the use of a camera(s) and facial recognition software/technology, or other individual identification technology that can be implemented. Manual identification by the customer also may be provided, such as the customer entering his/her cellular phone number or other unique identifier into a keypad or other device.

Thereafter, upon identifying the customer and confirmation of the purchase of a good or goods, the remaining steps/blocks identified in FIG. 7B are the same or similar to the corresponding steps/blocks shown in FIG. 7A.

FIG. 7C illustrates application 770 of the present invention within a retail store but without a cashier (i.e., cashier-less). In such embodiments, the customer logs into the retail store's system 772 and proceeds to perform a self-checkout 774 in the manner required by the retailer. It is noted that self-checkout may not require step 772 (i.e., “logging” in by the customer), but at some point customer identification needs to be performed. Any technique employed by retailers at the point of sale for enabling customers to purchase products without a cashier or other attendant may be employed. At the completion of the purchase, the system of the present invention receives payment confirmation (776). The following steps/blocks in FIG. 7C are the same or similar to the corresponding steps/blocks shown in FIGS. 7A and 7B.

As illustrated from the exemplary diagrams in FIGS. 7A, 7B, and 7C, along with the discussion of these figures herein, it is seen that the various embodiments of the present invention may be employed in both during “online” shopping and during in-person shopping. It is noted that the format of the shopping experience from the perspective of the customer may differ than that described herein. For instance, shopping may occur during a virtual reality experience by the customer/consumer, while watching streaming video that includes product purchase capability, or other shopping experience.

In a further example, the present invention may be implemented in retail stores that do not include cashiers or “check-out” counters at all. In such stores, technology sometimes referred to cashierless checkout technology is employed to identify a customer. The technology may employ facial recognition, use of a personal QR code, identification of a customer's cell phone via Bluetooth or other communication protocol, or other known or yet to be invented methodology for identifying a customer. Products picked up and retained by the customer while in the retail store are tracked, and then a purchase of products that the customer takes with him/her when he/she leaves the store is automatically carried out. All the information necessary to carry out the present invention in its various embodiments is obtained even in the cashierless retail store.

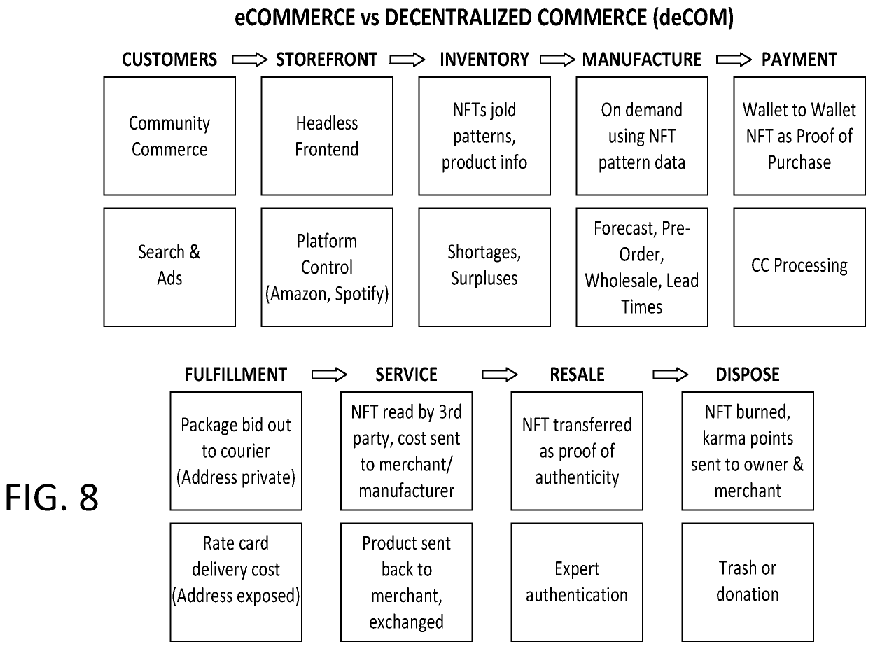

FIG. 8 schematically illustrates exemplary different applications that may be employed along with exemplary different types of activities that relate to products in accordance with the present invention. The NFT structure/methodology of the present invention provides various benefits to customers, retailers, manufacturers and other entities involved with goods pre-sale. On the delivery side, the present invention enables for the retaining and storing of data potentially useful for fulfillment, service, resale, and disposal, along with various applications that relate to these activities, such as authentication, donation, among other things listed in the figure and other things not listed.

As illustrated, the present invention may be employed for a large number of benefits that relate to a good during every stage of its entire life. For illustrative purposes, the present invention may be advantageously employed in connection with providing rewards in the form of cashback rebates. In this case, the proof of purchase using NFTs in accordance with certain embodiments described herein used in the context of cashback rebates is described in U.S. Provisional Patent Application No. 63/242,089 and entitled “Methods for Providing Cashback Rebates as Reward for Direct and Indirect Commerce Referrals.” U.S. Provisional Patent Application No. 63/242,089 is owned by the assignee hereof, the disclosure of which is incorporated herein by reference.

In another exemplary application of the invention, the use of proof of purchase via the herein described NFTs may be employed in methodologies that entail promotional campaigns and collective price rewards processes, as described in U.S. Provisional Patent Application No. 63/242,086, entitled “Methods for Dynamic Collective Bargaining Promotions Utilizing Cashback Rebates.” U.S. Provisional Patent Application No. 63/242,086 is owned by the assignee hereof, the disclosure of which is incorporated herein by reference.

Yet further other uses include payment for messaging (direct marketing, offers), payment for access (market research), analytics/advertising (AWS of collective data commerce), warranty services, and the multitude of uses and applications already mentioned herein, among other uses not mentioned.

In view of the foregoing detailed description of preferred embodiments of the present invention, it readily will be understood by those persons skilled in the art that the present invention is susceptible to broad utility and application. While various aspects have been described in the context of a preferred embodiment, additional aspects, features, and methodologies of the present invention will be readily discernible from the description herein by those of ordinary skill in the art. Many embodiments and adaptations of the present invention other than those herein described, as well as many variations, modifications, and equivalent arrangements and methodologies, will be apparent from or reasonably suggested by the present invention and the foregoing description thereof, without departing from the substance or scope of the present invention.

It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the present inventions. In addition, some steps may be carried out simultaneously.

The foregoing description of the exemplary embodiments has been presented only for the purposes of illustration and description and is not intended to be exhaustive or to limit the inventions to the precise forms disclosed. Many modifications and variations are possible in light of the above teaching.

The embodiments were chosen and described in order to explain the principles of the inventions and their practical application so as to enable others skilled in the art to utilize the inventions and various embodiments and with various modifications as are suited to the particular use contemplated. Alternative embodiments will become apparent to those skilled in the art to which the present inventions pertain without departing from their spirit and scope.

Accordingly, the scope of the present inventions is defined by the appended claims rather than the foregoing description and the exemplary embodiments described therein. While certain exemplary aspects and embodiments have been described herein, many alternatives, modifications, and variations will be apparent to those skilled in the art. Accordingly, exemplary aspects and embodiments set forth herein are intended to be illustrative, not limiting. Various modifications may be made without departing from the spirit and scope of the disclosure.

1. A system for electronically processing and providing proof of purchase and ownership using a non-fungible electronic cryptographic NFT token, comprising:
a processor that executes computer instructions stored in computer memory that cause the processor to:
receive and process metadata comprising purchase information for a purchase transaction involving a good purchased by a customer, wherein the purchase transaction comprises a purchase of a good with an agreement to transfer ownership of the purchased good to the customer;
receive and process customer information identifying the customer;
select and extract relevant data from the metadata and organize the purchase information;
automatically authenticate the metadata and verify that the purchase information is genuine;
determine whether the metadata or the customer information includes electronic wallet information;
create, if electronic wallet information is not included in the metadata or the customer information, a new electronic wallet for the customer;
mint an NFT purchase token at the time of the processing of said purchase transaction, wherein the minted NFT represents the authenticated and verified confirmation of said purchase transaction involving the good, and wherein the minted NFT represents the change of ownership for the good;
automatically arrange and provide computer instructions for the minted NFT purchase token to be appended on a blockchain, wherein the purchasing customer controls access to the minted NFT after the processing of the purchase transaction;
assign the minted NFT purchase token to the electronic wallet of the customer; and
generate a transaction fee for the minting and verification processing, and associate the generated transaction fee with the transaction.

2. The system of claim 1, wherein the processor executes computer instructions stored in the computer memory that further causes the processor to:
create a product entry that includes a minting fee for minting the NFT purchase token that represents the unique certificate of ownership for the purchased good, the created product entry that includes the minting fee enabling for the minting fee to be paid by the customer who purchased the good at or near the time of the processing of the purchase transaction.

3. The system of claim 2, wherein the processor executes computer instructions stored in the computer memory that further causes the processor to:
update the minting fee prior to receiving and processing the metadata that comprises purchase information for the good purchased by the customer.

4. The system of claim 2, wherein the processor executes computer instructions stored in the computer memory that further causes the processor to:
obtain at one or more times after the minting operation, an updated minting fee from a processor that executes a minting application that mints the NFT purchase token that represents the unique certificate of ownership for the purchased good.

5. The system of claim 1, wherein the metadata contains a unique identifier adapted to be used to obtain an electronic wallet address in an ID token smart contract.

6. The system of claim 5, wherein the unique identifier is a telephone number of the customer.

7. The system of claim 6, wherein the processor executes computer instructions stored in the computer memory that further causes the processor to:
transmit an SMS code to the telephone number of the customer in the metadata and perform a verification of an identity of the customer.

8. The system of claim 1, wherein the processor executes computer instructions stored in the computer memory that further causes the processor to:
transmit an email to an email address contained within the metadata or the customer information that requests a unique identifier of the customer.

9. The system of claim 1, wherein the processor executes computer instructions stored in the computer memory that further causes the processor to:
generate a private key in order to create an identification NFT token and assign the created NFT token using at least a portion of the generated private key.

10. The system of claim 1, wherein the minted NFT purchase token comprises multiple sub-tokens, each of the sub-tokens representing a different transaction involving a change in ownership of the purchased good.

11. The system of claim 10, wherein the sub-tokens include confidential data accessible only to the respective entity to which the sub-token pertains.

12. The system of claim 1, wherein the processor executes computer instructions stored in the computer memory that causes the processor to:
generate the metadata comprising the purchase information for the good when purchased by the customer at a location representing a point of purchase location.

13. The system of claim 12, wherein the processor executes computer instructions stored in the computer memory that causes the processor to:
receive, when the customer is at the point of purchase location, data representing an identity of the customer.

14. A method of electronically processing and providing proof of purchase and ownership using a non-fungible electronic cryptographic NFT tokens, comprising:
receiving and processing metadata comprising purchase information for a purchase transaction involving a good purchased by a customer, wherein the purchase transaction comprises a purchase of a good with an agreement to transfer ownership of the purchased good to the customer;
receiving and process customer information identifying the customer;
selecting and extracting relevant data from the metadata and organizing the purchase information;
automatically authenticating the metadata and verifying that the purchase information is genuine;
determining whether the metadata or the customer information includes electronic wallet information;
creating, if electronic wallet information is not included in the metadata or the customer information, a new electronic wallet for the customer;
minting an NFT purchase token at the time of the processing of said purchase transaction, wherein the minted NFT represents the authenticated and verified confirmation of said purchase transaction involving the good, and wherein the minted NFT represents the change of ownership for the good;
automatically arranging and providing computer instructions for the minted NFT purchase token to be appended on a blockchain, wherein the purchasing customer controls access to the minted NFT after the processing of the purchase transaction;
assigning the minted NFT purchase token to the electronic wallet of the customer; and
generating a transaction fee for the minting and verification processing, and associating the generated transaction fee with the transaction.

15. The method of claim 14, comprising creating a product entry that includes a minting fee for minting the NFT purchase token that represents the unique certificate of ownership for the purchased good, the created product entry that includes the minting fee enabling for the minting fee to be paid by the customer who purchased the good.

16. The method of claim 15, comprising updating the minting fee prior to receiving and processing the metadata that comprises purchase information for the good purchased by the customer.

17. The method of claim 15, comprising obtaining, at one or more times after the minting operation, an updated minting fee from a processor that executes a minting application that mints the NFT purchase token that represents the unique certificate of ownership for the purchased good.

18. The method of claim 14, wherein the metadata contains a unique identifier adapted to be used to obtain an electronic wallet address in an ID token smart contract.

19. The method of claim 18, wherein the unique identifier is a telephone number of the customer.

20. The method of claim 19, comprising transmitting an SMS code to the telephone number of the customer in the metadata performing a verification of an identity of the customer.
